(19) United States
(12) Patent Application Publication
(10) Pub. No.: US 2016/0155284 A1
(43) Pub. Date: Jun. 2, 2016

(54) MONEY PROCESSING APPARATUS AND MONEY PROCESSING METHOD

(71) Applicant: Kabushiki Kaisha Toshiba, Tokyo (JP)

(72) Inventor: Kazuhiko Tabata, Kanagawa-ken (JP)

(21) Appl. No.: 14/951,738

(22) Filed: Nov. 25, 2015

(30) Foreign Application Priority Data
Nov. 28, 2014 (JP) 2014-242418

(51) Int. Cl. G07D 11/00

(52) U.S. Cl. CPC G07D 11/0084; G07D 11/0021

(57) ABSTRACT

A money processing apparatus according to an embodiment includes: a take out unit that takes out sheet-like moneys one by one; a denomination determining unit that determines denominations of the sheet-like moneys taken out by the tale out unit; and a plurality of processing units that discriminates the sheet-like moneys determined by the denomination determining unit and accumulates the sheet-like moneys according to the denomination, wherein power supply to the plurality of processing units having different denominations is individually controlled.

### CROSS-REFERENCE TO RELATED APPLICATIONS

This application is based upon and claims the benefit of priority from the prior Japanese Patent Applications No. 2014-242418 filed on Nov. 28, 2014, the entire contents of which are incorporated herein by reference.

### FIELD

Embodiments described herein relate generally to a money processing apparatus and a money processing method.

### BACKGROUND

A conventional paper money processing apparatus takes out paper moneys one by one in a state in which different denominations of the paper moneys (bills or bank notes) are stacked, determines the denominations, accumulates a predetermined number of the paper moneys having the same denomination, and seals the paper moneys.

The paper money processing apparatus includes a plurality of accumulating units and a plurality of banding units corresponding to the denominations. Each of the accumulating units accumulates, for examples, 100 sheets of paper moneys.

Each of the banding units includes a wrapper band and a heating unit. A thermal-bonding glue (adhesive) is applied on one surface of the wrapper band. An end of the wrapper band wound around the paper moneys is overlapped on the wound wrapper band, and the overlapped portion is thermally bonded by heating and pressurization using the heating unit. Thus, a banded bunch is provided.

The heating unit maintains a bonding temperature necessary for bonding when power is always in an ON state from the startup to the close of business. A time is required from the start of the accumulation of the paper moneys to the banding of 100 sheets of the paper moneys, but each of the heating units continues to consume power so as to maintain a constant temperature even during that time.

In particular, with regard to the denomination whose circulation is small, it is wasteful because the heating unit continues to consume power, in spite of a low frequency from the start of the accumulation to the banding of 100 accumulated sheets.

### BRIEF DESCRIPTION OF THE DRAWINGS

FIG. 1 is a configuration diagram of a paper money processing apparatus according to an embodiment.

FIG. 2 is a perspective view schematically illustrating an example of a banding unit during winding of a banding material according to an embodiment.

FIG. 3 is a cross-sectional view schematically illustrating an example of the banding unit after the winding of the banding material according to an embodiment.

FIG. 4 is a diagram illustrating an example of a client-specific setting storing unit according to an embodiment.

FIG. 5 is a diagram illustrating a flow of a selecting process of client-specific setting according to an embodiment.

FIG. 6 is a diagram illustrating an example of a flow of switching a power supply state to an arbitrary banding material heating unit according to an embodiment.

FIG. 7 is a diagram illustrating an example of a flow of switching a power supply state to an arbitrary binding material heating unit according to an embodiment.

FIG. 8 is a diagram illustrating an example of a flow of switching a power supply state to a film heating unit according to an embodiment.

FIG. 9 is a configuration diagram of a paper money processing apparatus according to another embodiment.

### DETAILED DESCRIPTION

Hereinafter, embodiments of the present invention will be described with reference to the drawings.

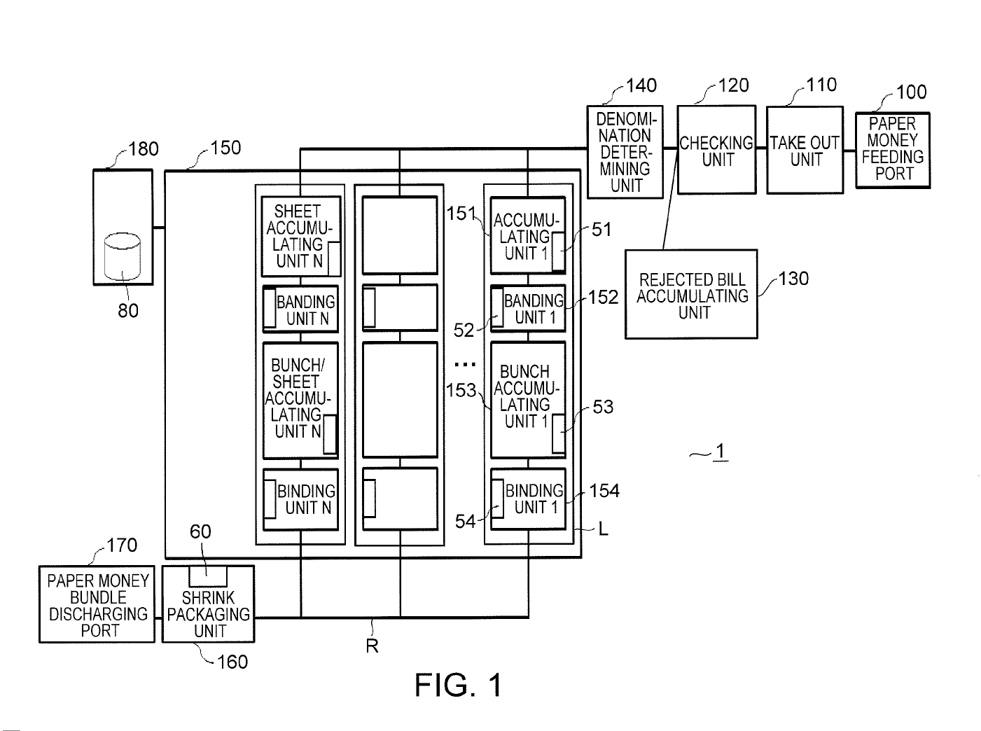

FIG. 1 is a configuration diagram of a paper money processing apparatus according to an embodiment of the present invention. A configuration of the paper money processing apparatus according to the embodiment will be described with reference to FIG. 1. A paper money processing apparatus 1 according to the embodiment includes a paper money feeding port 100, a take out unit 110, a checking unit 120, a rejected bill accumulating unit 130, a denomination determining unit 140, a banding/binding module 150, a shrink packaging unit 160, a paper money bundle discharging port 170, and a control unit 180.

The paper money feeding port 100 allows an operator or the like to insert and feed paper moneys (sheet-like money) in which a plurality of denominations is mixed. The take out unit 110 (ejecting unit) takes out the fed paper moneys one by one. The ejected paper moneys are conveyed by a conveyance path. The checking unit 120 provided in the middle of the conveyance path checks the authenticity of the paper money. The rejected bill accumulating unit 130 accumulates paper moneys determined as counterfeit bills or paper moneys whose authenticity or denominations cannot be determined due to ejection of a plurality of sheets. The denomination determining unit 140 determines the denomination of the paper money.

The banding/binding module 150 bands and binds the paper moneys by denomination. The banding/binding module 150 includes N lanes each having an accumulating unit 151, a banding unit 152, a bunch accumulating unit 153, and a binding unit 154 as one set. The lane can be referred to as a processing lane or an accumulating lane. Two lanes may be allocated for each denomination. For example, two lanes are allocated as lanes dedicated to an A bill (e.g., 1,000-yen bill), two lanes are allocated as lanes dedicated to a B bill (e.g., 5,000-yen bill), and two lanes are allocated as lanes dedicated to a C bill (e.g., 10,000-yen bill). This is intended to accumulate paper moneys in another lane while 100 sheets of 1,000-yen bills are accumulated in the accumulating unit 151 of the 1,000-yen bill lane and the 100 sheets of the 1,000-yen bills are ejected and banded.

The accumulating unit 151 accumulates the paper moneys by denomination. Each of the accumulating units 151 includes a sheet counting unit 51 that counts the number of sheets of paper moneys accumulated in each of the accumulating unit 151.

When 100 sheets of the paper moneys are accumulated in the accumulating unit 151, the accumulated paper moneys are taken out and the banding unit 152 bands and seals the accumulated paper moneys. Each of the banding units 152 includes a banding material heating unit 52. For the purpose of thermal bonding, the banding material heating unit 52 heats an overlapped portion of a banding material which is a banding wrapper band. Details will be described below.

The bunch accumulating unit 153 accumulates banded paper money bunches. Each of the bunch accumulating units 153 includes a bunch counting unit 53 that counts the number of the paper money bunches accumulated in each of the bunch accumulating unit 153.

When 10 paper money bunches are accumulated in the bunch accumulating unit 153, the paper money bunches are ejected and the binding unit 154 binds the accumulated paper money bunches. Each of the binding units 154 includes a binding material heating unit 54. For the purpose of thermal bonding, the binding material heating unit 54 heats a binding material which is a binding wrapper band. Details will be described below.

The paper money bundles bound by each of the binding units 154 are discharged from each lane to a common conveyance path R. The discharged paper money bundles are conveyed through the common conveyance path and is sent to the shrink packaging unit 160. The shrink packaging unit 160 packages the paper money bundles bound by each of the binding units 154. The shrink packaging unit 160 includes a film heating unit 60. The film heating unit 60 packages the paper money bundles by thermally shrinking a film for shrink package.

The paper money bundle discharging port 170 discharges the packaged paper money bundle from the paper money processing apparatus 1.

Finally, the control unit 180 (controller) controls an overall operation of the paper money processing apparatus in each unit. For example, the control unit 180 gives an instruction to convey the accumulated paper moneys from the accumulating unit 151 to the banding unit 152, based on the counting result of the sheet counting unit 51. The control unit 180 includes a client-specific setting storing unit 80 (memory) that stores client-specific setting to be described below. The control unit 180 includes, for example, a CPU, a memory, a peripheral circuit, and the like. The client-specific setting storing unit 80 includes, for example, rewritable ROM or RAM.

Hereinafter, the operation of the paper money processing apparatus 1 according to the embodiment will be described.

First, paper moneys to be processed by the paper money processing apparatus are fed by inserting the paper moneys into the paper money feeding port 100 in a state in which a plurality of denominations of paper moneys are stacked. Then, the fed paper moneys being in the stacked state are taken out one by one by the take out unit 110.

Subsequently, the paper moneys taken out one by one are conveyed to the checking unit 120 through the conveyance path. The checking unit 120 checks the authenticity of the conveyed paper moneys. Specifically, it is determined whether the paper money is true or the paper money is false, that is, a rejected bill. Here, the rejected bill is a bill determined as a counterfeit bill, or a bill that cannot be discriminated by folding, damage, skew, ejection of two sheets, or the like. The skew means that a paper money is conveyed in a state of being inclined with respect to a direction perpendicular to a conveying direction.

The paper money determined as the rejection bill is conveyed to the rejected bill accumulating unit 130. On the other hand, the other true bills are conveyed to the denomination determining unit 140. The denomination determining unit 140 determines the denomination of the paper money. For example, it is determined whether the paper money is the 1,000-yen bill, the 5,000-yen bill, or the 10,000-yen bill. Each of the paper money is allocated and conveyed to the lane according to the denomination, based on the determination result of the denomination determining unit 140.

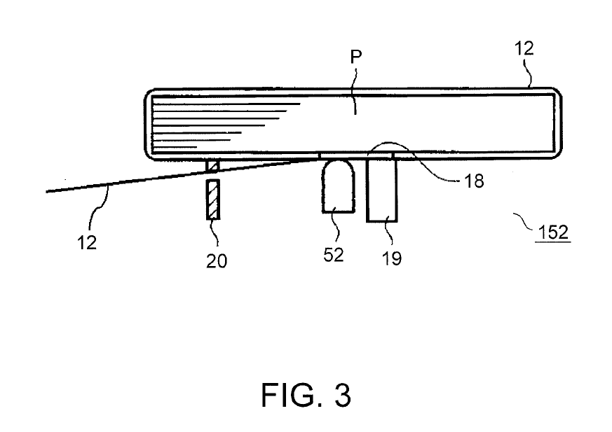

In each lane, the conveyed paper moneys are accumulated in the accumulating unit 151. Generally, an impeller in which a plurality of blades is incorporated around a rotational shaft is provided in the accumulating unit 151, and the blades are rotated such that the conveyed paper moneys are received between the blades. Therefore, it is a mechanism that accumulates the conveyed paper moneys in the accumulating unit 151 while positioning the paper moneys one by one. The mechanism of the accumulating unit 151 is configured as described in, for example, FIG. 3 of Japanese Patent Disclosure No. 2012-198813, the entire contents of which are incorporated herein by reference.

Whenever one paper money is accumulated in the accumulating unit 151, the number of the accumulated sheets is counted by the sheet counting unit 51. When a predetermined number of paper moneys, for example, 100 sheets of paper moneys, are counted as being accumulated, the accumulated paper moneys are taken out and conveyed to the banding unit 152. Along with this, the counting of the sheet counting unit 51 is reset, and the sheet counting unit 51 starts again to count the number of sheets of paper moneys accumulated in the accumulating unit 151.

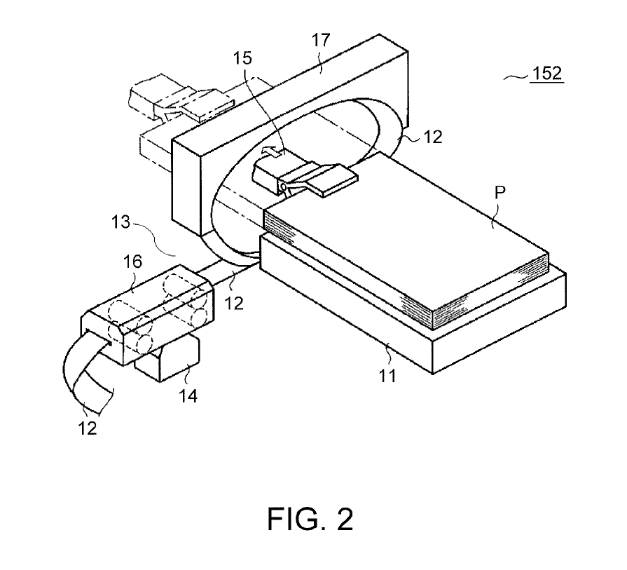

In the banding unit 152, the accumulated paper moneys are banded and sealed by thermal bonding. A thermal-bonding glue is applied on one surface of a banding material used for banding. An end of the banding material wound around the paper moneys is overlapped on the wound banding material, and the overlapped portion is thermally bonded by heating and pressurization using the banding material heating unit 52. Therefore, one paper money bunch in which 100 sheets of paper moneys are banded by the banding material is provided. The configuration of the banding unit 152 will be described below with reference to FIGS. 2 and 3.

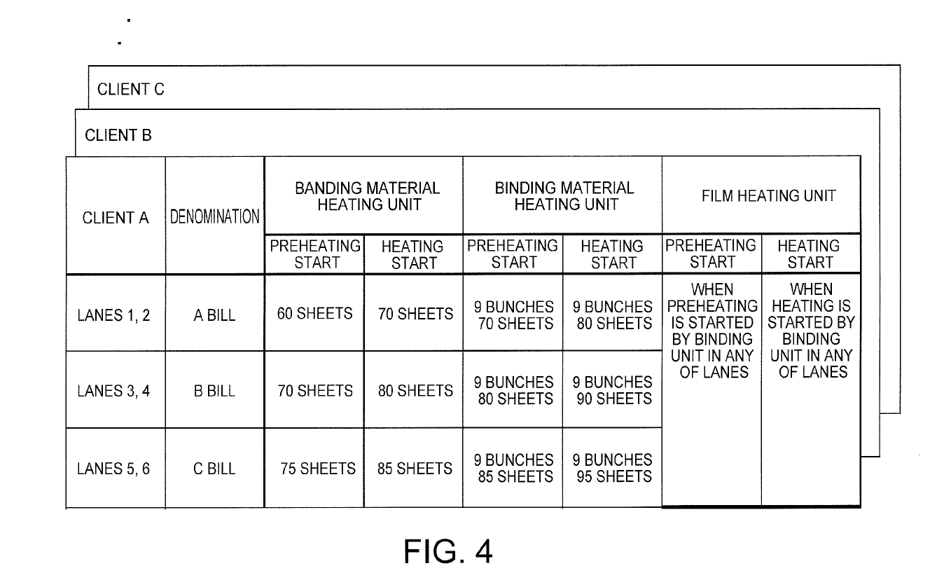

The banding material heating unit 52 heats the overlapping portion of the banding material to a predetermined temperature. The heating of the banding material heating unit 52 is controlled by the instruction of the control unit 180. That is, the control unit 180 detects an accumulated status of the paper money from count information of the sheet counting unit 51 and controls a power supply to each of the banding material heating units 52, based on the client-specific setting to be described below. Specifically, the power is switched to an OFF state and a heating state. Alternatively, the power is switched to an OFF state, a preheating state, and a heating state. The control of the power supply to each of the banding material heating units 52 will be described below with reference to FIGS. 4 to 6.

Here, the heating means applying heat (starting to supply power) until a temperature reaches a temperature necessary for thermal bonding (thermally bondable temperature) T1 and maintaining the temperature after the temperature reaches the temperature necessary for thermal bonding. In addition, the preheating means applying heat (starting to supply preheating power) until a temperature reaches a temperature T2 (thermal bonding preparation temperature) such that the temperature is easily raised, in order for heating until the temperature necessary for thermal bonding, and maintaining the temperature T2 after the temperature reaches the temperature T2. (T2<T1)

Subsequently, the banded paper money bunches are conveyed to the bunch accumulating unit 153 and the paper money bunches are accumulated bunch by bunch. The bunch accumulating unit 153 is positioned below the banding unit 152. Whenever the paper money bunches are accumulated in the bunch accumulating unit 153, the number of the accumulated bunches is counted by the bunch counting unit 53. When the accumulation of 10 paper money bunches is counted by the bunch counting unit 53, the accumulated paper money bunches are conveyed to the binding unit 154. The binding unit 154 is positioned below the bunch accumulating unit 153. Along with this, the counting of the bunch counting unit 53 is reset, and the bunch counting unit 53 starts again to count the number of paper money bunches accumulated in the bunch accumulating unit 153.

The binding unit 154 binds the accumulated paper money bunches by winding the wrapper band and provides a paper money bundle. The binding material heating unit 54 heats the bonding portion of the binding material to a predetermined temperature. The heating of the binding material heating unit 54 is controlled by the instruction of the control unit 180. That is, the control unit 180 acquires the number of the accumulated paper money bunches from the count information of the bunch counting unit 53, acquires the number of the accumulated sheets of the paper moneys from the count information of the sheet counting units 51 of the accumulating units 151 belonging to the same lanes, and controls the power supply to the binding material heating units 54, based on the client-specific setting to be described below. The control of the power supply to each of the binding material heating units 54 will be described below with reference to FIGS. 4, 5, and 7.

Subsequently, the bound paper money bundle is conveyed to the shrink packaging unit 160. The shrink packaging unit 160 covers the paper money bundle with a heat-shrinkable film that is shrunk when heat is applied thereto, and packages the paper money bundle by heat-shrinking the film.

In the shrink packaging, the heating means applying heat (starting to supply power) until a temperature reaches a temperature necessary for packaging (heat-shrinkable temperature) and maintaining the temperature after the temperature reaches the temperature necessary for packaging. In addition, the preheating means applying heat (starting to supply preheating power) until a temperature reaches a temperature (heat-shrinkable preparation temperature) such that the temperature is easily raised, in order for heating until the temperature necessary for packaging, and maintaining the temperature after the temperature reaches the temperature necessary for packaging.

Finally, the packaged paper money bundle is conveyed to the paper money bundle discharging port 170 and is discharged from the paper money processing apparatus. Up to this, a series of operation flow of the paper money processing apparatus has been described.

Here, the configuration of the banding unit 152 will be described in detail with reference to FIGS. 2 and 3.

FIG. 2 is a perspective view schematically illustrating an example of the banding unit during the winding of the banding material according to the present embodiment. The banding unit 152 includes a support table 11, a banding material feeding mechanism 13, a printer 14, and a gripping/retracting (pull in) mechanism 15. The banding material feeding mechanism 13 includes a banding material feeder 16, a banding material catcher (not illustrated), and a banding material guide 17.

The support table 11 is a substantially rectangular table in which 100 sheets of accumulated paper moneys P ejected from the accumulating unit 151 are placed. The back side of the support table 11 will be described below with reference to FIG. 3.

The banding material feeding mechanism 13 feeds a banding material 12 for banding the accumulated paper moneys P placed in the support table 11. The banding material feeder 16 feeds the banding material 12 to the rear of the support table 11 (in a right upper direction in the drawing). The banding material catcher grips and rotates a leading end of the fed banding material 12. At the time of rotation of the banding material catcher, the banding material guide 17 guides and feeds the gripped banding material 12 in a loop shape.

The printer 14 is provided side by side with the banding material feeding mechanism 13 and prints desired print information on the banding material 12.

The gripping/retracting mechanism 15 grips the accumulated paper moneys P, retracts the accumulated paper moneys P to the middle of the loop-shaped banding material 12, and determines a banding position of the accumulated paper moneys P.

Hereinafter, the banding operation of the banding unit 152 according to an embodiment will be described.

100 sheets of paper moneys P accumulated in the accumulating unit 151 are ejected and placed on the support table 11. On the other hand, the banding material 12 is ejected from a banding material reel (not illustrated) and is fed to the back side of the support table 11 by the banding material feeder 16 of the banding material feeding mechanism 13. At this time, desired information is printed on the banding material 12 by the printer 14. The leading end of the banding material 12 is gripped by the banding material catcher. The gripped banding material 12 is guided and rotated in a loop shape by the banding material guide 17. Therefore, the banding material 12 wound in the loop shape is provided. The accumulated paper moneys P are retracted to a banding position (position of the accumulated paper moneys P indicated by a dashed line in FIG. 2) in an arrow direction of FIG. 2 by the gripping/retracting mechanism 15 and pass through the middle of the loop-shaped banding material 12.

FIG. 3 is a cross-sectional view schematically illustrating an example of the banding unit 152 after the winding of the banding material according to the present embodiment. The banding unit 152 includes an ironing board 18, a banding material heating unit 52, a banding material clamp 19, and a cutter 20 on the back side (the lower side in FIG. 3) of the retracted accumulated paper moneys P.

The ironing board 18 is inserted between the accumulated paper moneys P and the banding material 12, so that the banding material is not thermally bonded to the paper money. At the time of bonding, the banding material clamp 19 fixes the overlapped portion of the banding material 12, which is wound around the accumulated paper moneys P, onto the ironing board 18. The banding material heating unit 52 presses the overlapped portion of the banding material against the ironing board 18 and thermally bonds the overlapped portion by heating. The cutter 20 cuts the banding material 12 after the banding is completed.

The ironing board 18 and the cutter 20 are provided to be reciprocable in a longitudinal direction (arrow direction of FIG. 2) of the support table 11. In addition, the banding material heating unit 52 and the banding material clamp 19 are provided to be vertically movable between a position abutting against the banding material 12 and a position spaced apart from the banding material 12.

Hereinafter, the latter half of the banding operation of the banding unit 152 according to an embodiment will be described.

After the accumulated paper moneys P are moved to the banding position of FIG. 2 by the gripping/retracting mechanism 15, the banding material feeding mechanism 13 retracts the banding material 12. Due to this, the banding material 12 is wound in close proximity to the periphery of the accumulated paper moneys P.

At the same time as the retracting operation, the ironing board 18 and the cutter 20 also are moved to the banding position. The ironing board 18 is inserted between the accumulated paper moneys P and the banding material 12, and the cutter 20 is set at a position sandwiching the end of the banding material 12. In addition, the banding material heating unit 52 and the banding material clamp 19 also are moved to a position abutting against the banding material 12.

The overlapped portion of the ironing board 18 and the banding material 12 is fixed by the banding material clamp 19. The overlapped portion of the banding material 12 is heated by the banding material heating unit 52. Thus, the thermal-bonding glue applied on the inner side of the overlapped portion of the banding material is melted, and the thermal bonding is completed. Finally, the end of the banding material 12 is cut by the cutter 20. The banding is completed and the paper money bunch is provided.

Next, the client-specific setting will be described with reference to FIG. 4.

FIG. 4 is a diagram illustrating an example of the client-specific setting storing unit according to the present embodiment. The client of the paper money to be treated by the paper money processing apparatus is characterized by the number of sheets of denominations of paper moneys with respect to each client. Based on this characteristic, ‘client-specific setting’ is previously stored together with client information in the client-specific setting storing unit 80 included in the control unit 180.

The client information is information for identifying a client, such as a client name, a client code. For example, in a case where the paper money processing apparatus is installed in a centralized processing department or a cash processing center of a bank's head office, a major client of each branch of the bank or a department store or the like is a main client. In addition, in a case where the paper money processing apparatus is installed in the branch of the bank, a store or the like is a main client. Furthermore, in a case where the paper money processing apparatus is installed in the department store or the like, each floor is a client. Paper moneys collected at each client are inserted into the paper money processing apparatus.

Paper moneys deposited from each client are characterized by the configuration of denomination with respect to each client. For example, in the case of a shopping center or a store, most of paper moneys are 1,000-yen bills. In addition, in the case of a department store in a big city, it is characterized in that a ratio of 10,000-yen bills is high.

For this reason, ‘client-specific setting’ is previously stored in the client-specific setting storing unit 80 with respect to each client according to a large number of denomination of each client in the past. Hereinafter, details will be described.

From a number of denomination of each client, for example, it is possible to expect the time from the start of accumulation of paper moneys to the start of banding due to the completion of the accumulation with respect to each denomination. This time is referred to as an expected accumulation time. On the other hand, the time required until the banding material heating unit 52 reaches a temperature necessary for thermal bonding is referred to as an expected heating time. Before elapse of the expected accumulation time, it is possible to assume an optimal timing to switch the power supply state of the banding material heating unit 52 so that the banding material heating unit 52 reaches the temperature necessary for thermal bonding. The timing used herein depends on the number of accumulated sheets, just like starting of heating, when M sheets are accumulated in the accumulating unit 151. Storing this timing in advance is the client-specific setting. That is, the client-specific setting is stored in the client-specific setting storing unit by storing a client of paper moneys to be processed, an accumulating unit to accumulate paper moneys by denomination (i.e., information about which domination corresponds to a lane or which lane a domination corresponds to), and the number of accumulated sheets to which the heating starts when the banding material heating unit starts to heat to a thermally bondable temperature, in association with one another.

Standard setting is also stored in the client-specific setting storing unit 80, separately from the client-specific setting. For example, the standard setting is applied when paper moneys of a client whose client-specific setting is not set are processed.

Similarly, in the binding material heating unit 54, the client-specific setting and the standard setting are stored in the client-specific setting storing unit 80.

In addition, in the film heating unit 60 of the shrink packaging unit 160, a predetermined timing is stored in the client-specific setting. Here, the predetermined timing is, for example, a timing of switching a power supply state according to detection information obtained when the control unit 180 frequently detects the banding status and the binding status, in the entire banding/binding module 150, rather than setting based on the expected accumulation time and the expected heating time of the paper money bundle.

FIG. 4 is a diagram illustrating an example of the client-specific setting according to an embodiment. This is a table showing an example of a client-specific setting allocated to a client A. The paper money processing apparatus includes six lanes each having the accumulating unit 151, the banding unit 152, the bunch accumulating unit 153, and the binding unit 154 as one set. Each row represents contents set to each lane. Each column represents, from left to right, a lane, a denomination of paper money to be handled, a preheating start timing (number of accumulated sheets to which the preheating is to be started) of the banding material heating unit 52, a heating start timing (number of accumulated sheets to which the heating is to be started) of the banding material heating unit 52, a preheating start timing (number of accumulated bunches and number of accumulated sheets to which the preheating is to be started) of the binding material heating unit 54, a heating start timing (number of accumulated bunches and number of accumulated sheets to which the heating is to be started) of the binding material heating unit 54, a preheating start timing (preheating start condition) of the film heating unit 60, and a heating start timing (heating start condition) of the film heating unit 60. In this example, it is assumed that 100 sheets of paper moneys are banded as one paper money bunch, and 10 paper money bunches are bound as one paper money bundle.

For example, paper moneys undertaken from the client A are roughly characterized in that A bills (1,000-yen bills) occupy 60% of the entire paper moneys, B bills (5,000-yen bills) occupy 25% of the entire paper moneys, and C bills (10,000-yen bills) occupy 15% of the entire paper moneys. The client-specific setting of the client A, which is stored in the client-specific setting storing unit 80, is stored such that the first lane and the second lane process the 1,000-yen bills, the third lane and the fourth lane process the 5,000-yen bills, and the fifth lane and the sixth lane process the 10,000-yen bills.

In the case of the 1,000-yen bills having the largest number of sheets to be processed, the time until 100 sheets are accumulated in the accumulating unit 151 is short, as compared with other denominations. That is, the expected accumulation time is short. Therefore, in the case of the 1,000-yen bills handled by the client A, the preheating is started at the time point when relatively small ‘60 sheets’ of paper moneys are accumulated, and then, the heating is started at the time point when ‘70 sheets’ are accumulated. Therefore, the banding material heating unit 52 is set to reach a temperature necessary for thermal bonding at the time point when ‘100 sheets’ are accumulated.

On the other hand, in the case of the 10,000-yen bills having the small number of sheets to be processed, the time until 100 sheets are accumulated in the accumulating unit 151 is long. That is, the expected accumulation time is long. Therefore, with regard to the 10,000-yen bills handled by the client A, the preheating is started at the time point when relatively many ‘75 sheets’ of paper moneys are accumulated, and then, the heating is started at the time point when ‘85 sheets’ are accumulated. Therefore, the banding material heating unit 52 is set to reach a temperature necessary for thermal bonding at the time point when ‘100 sheets’ are accumulated.

The binding material heating unit 54 also is set in a similar manner. Therefore, in the case of the 1,000-yen bills having a short expected accumulation time, the preheating is started at the time point when ‘9 paper money bunches’ and relatively small ‘70 sheets’ of paper moneys are accumulated (that is, 9 paper money bunches+70 sheets), and then, the heating is started at the time point when ‘9 paper money bunches’ and ‘80 sheets’ of paper money are accumulated.

On the other hand, in the case of the 10,000-yen bills having a long expected accumulation time, the preheating is started at the time point when ‘9 paper money bunches’ and relatively many ‘85 sheets’ of paper moneys are accumulated, and then, the heating is started at the time point when ‘9 paper money bunches’ and ‘95 sheets’ of paper money are accumulated. Therefore, the binding material heating unit 54 is set to reach a temperature necessary for thermal bonding at the time point when ‘10 paper money bunches’ are accumulated.

In addition, the setting according to the binding status of the paper money bunch is set in the film heating unit 60. For example, it is set such that the preheating of the film heating unit 60 is started at the time point when the binding material heating unit 54 starts the preheating in any of the first to sixth lanes, and the heating of the film heating unit 60 is started at the time point when the binding material heating unit 54 starts the heating in any of the first to sixth lanes.

The predetermined setting is only an example and any setting based on the banding or binding status of the paper moneys may be performed.

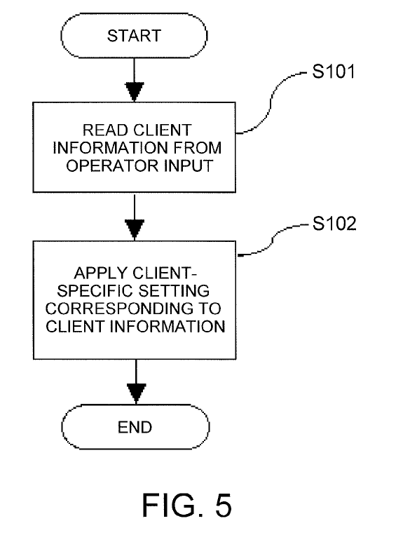

Next, the control of the power supply to each unit of the paper money processing apparatus will be described with reference to FIGS. 5 to 8.

FIG. 5 is a diagram illustrating a flow of a selecting process of client-specific setting according to an embodiment. At the time of starting the paper money processing, an operator or the like inputs client information about from which client the paper moneys to be processed are input. The control unit 180 reads the client-specific setting, which has been described above with reference to FIG. 4, from the client-specific setting storing unit 80, based on the input client information (step S101). The client-specific setting is applied to each lane (step S102).

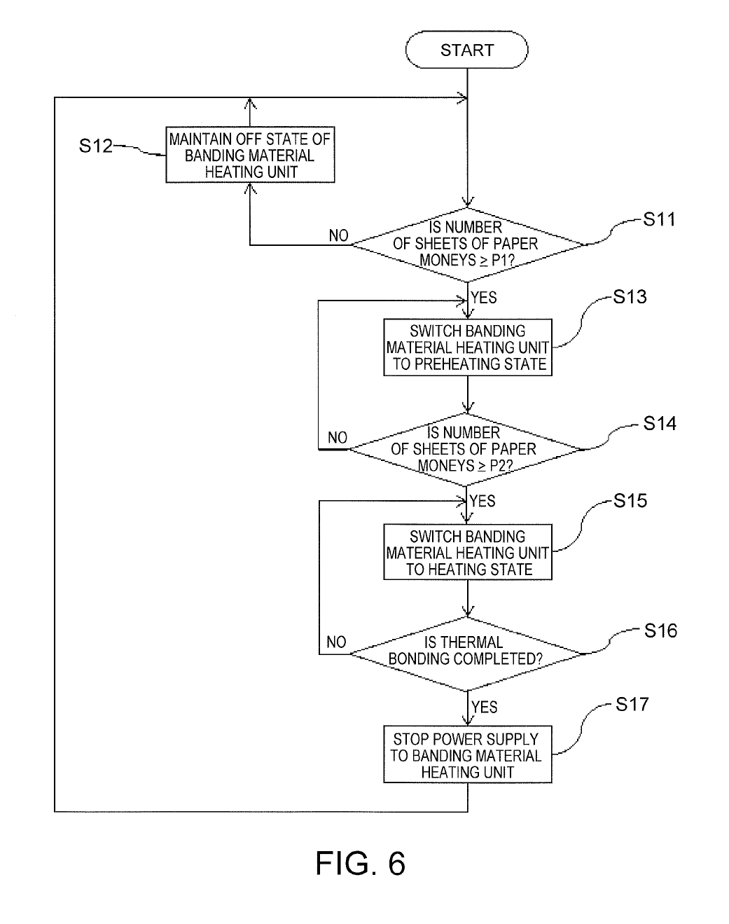

FIG. 6 is a diagram illustrating an example of a flow of switching the power supply state to the banding material heating unit 52 of the banding unit 152 of a certain lane in an arbitrary client-specific setting. In the banding material heating unit 52, the number of accumulated paper moneys which is the preheating start timing (number of accumulated sheets to which the preheating is to be started) is set as P1. In addition, the number of accumulated paper moneys which is the heating start timing (number of accumulated sheets to which the heating is to be started) is set as P2. For example, if associated with the banding material heating unit 52 in the first and second lanes of the client-specific setting of FIG. 4, P1 corresponds to 60 sheets and P2 corresponds to 70 sheets.

In the accumulating unit 151 that is present upstream of the banding unit 152, when the number of sheets of the accumulated paper moneys is less than P1 (NO of step S11), the control unit 180 maintains an OFF state of the banding material heating unit 52 (step S12). When the number of sheets of the accumulated paper moneys reaches P1 (YES of step S11), the control unit 180 switches the banding material heating unit 52 to a preheating state (step S13).

Subsequently, in the accumulating unit 151, it is checked whether or not the number of sheets of the accumulated paper moneys reaches P2. When the number of sheets of the accumulated paper moneys does not reach P2 (NO of step S14), the preheating state is maintained. When it is checked that the number of sheets of the accumulated paper moneys reaches P2 (YES of step S14), the control unit 180 switches the banding material heating unit 52 to a heating state (step S15).

Then, when 100 sheets of paper moneys accumulated in the accumulating unit 151 are fed to the banding unit 152. When the banding material is wound around the 100 sheets of the accumulated paper moneys and the thermal bonding is completed (YES of step S16), the power supply state of the banding material heating unit 52 is set to OFF (step S17) and the process returns to step S11 to repeat the subsequent processes for next banding.

Only the banding unit 152 of the first and second lanes has been described, but the same processing is performed to each banding unit 152 in parallel.

In a case where the banding material heating unit 52 has only two stages, i.e., the OFF state and the heating state, without passing through the preheating state, steps S11 and S13 described above are omitted.

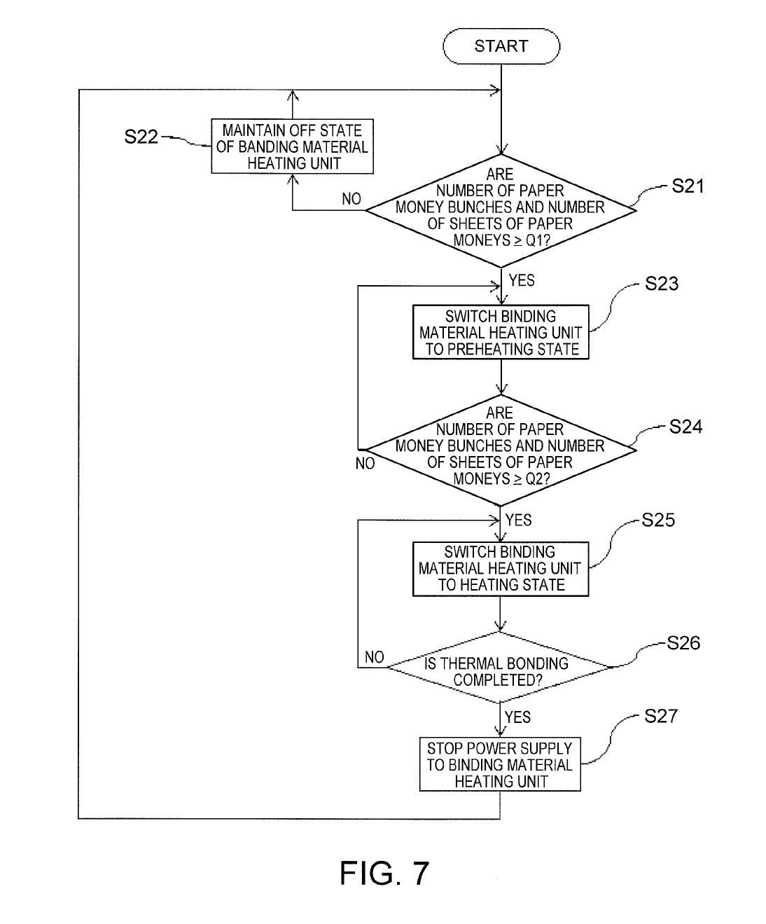

FIG. 7 is a diagram illustrating an example of a flow of switching the power supply state to the binding material heating unit 54 of the binding unit 154 of a certain lane in an arbitrary client-specific setting. In the binding material heating unit 54, the number of accumulated paper money bunches and the number of accumulated paper moneys which is the preheating start timing (number of accumulated bunches and number of accumulated sheets to which the preheating is to be started) is set as Q1. In addition, the number of accumulated paper money bunches and the number of accumulated paper moneys which is the heating start timing (number of accumulated bunches and number of accumulated sheets to which the heating is to be started) is set as Q2. For example, if associated with the binding material heating unit 54 in the first and second lanes of the client-specific setting of FIG. 4, Q1 corresponds to 9 bunches and 70 sheets and Q2 corresponds to 9 bunches and 80 sheets.

When the number of paper money bunches accumulated in the bunch accumulating unit 153 that is present upstream of the binding unit 154 and the number of sheets of paper moneys accumulated in the accumulating unit 151 that is present upstream is less than Q1 (NO of step S21), the control unit 180 maintains an OFF state of the binding material heating unit 54 (step S22). When the number of the accumulated paper money bunches and the number of sheets of the accumulated paper moneys reach Q1 (YES of step S21), the control unit 180 switches the binding material heating unit 54 to a preheating state (step S23).

Subsequently, in the bunch accumulating unit 153 and the accumulating unit 151, it is checked whether or not the number of the accumulated paper money bunches and the number of sheets of the accumulated paper moneys reach Q2. When the number of the accumulated paper money bunches and the number of sheets of the accumulated paper moneys do not reach Q2 (NO of step S24), the preheating state is maintained. When it is checked that the number of the accumulated paper money bunches and the number of sheets of the accumulated paper moneys reach Q2 (YES of step S24), the control unit 180 switches the binding material heating unit 54 to a heating state (step S25).

Then, when 10 paper money bunches accumulated in the bunch accumulating unit 153 are fed to the binding unit 154. When the binding material is wound around the 10 paper money bunches and the thermal bonding is completed (YES of step S26), the power supply state of the binding material heating unit 54 becomes OFF (step S27) and the process returns to step S21 to repeat the subsequent processes for next binding.

Only the binding unit 154 of the first and second lanes has been described, but the same processing is performed to each binding unit 154 in parallel.

In a case where the binding material heating unit 54 has only two stages, i.e., the OFF state and the heating state, without passing through the preheating state, steps S21 and S23 described above are omitted.

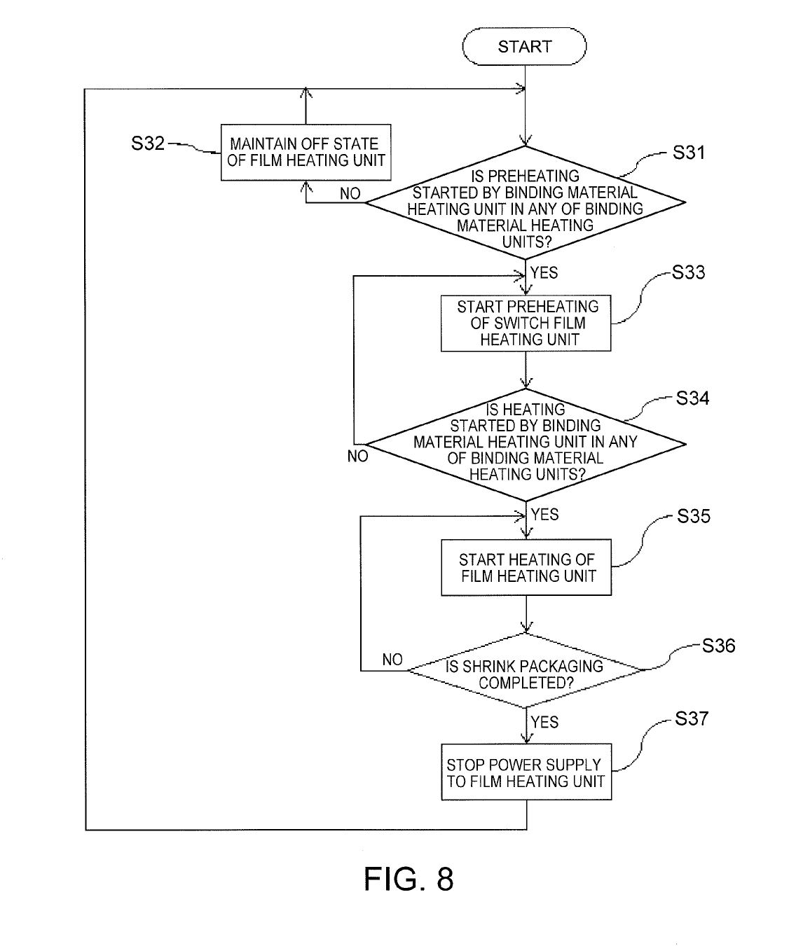

Further, FIG. 8 is a diagram illustrating an example of a flow of switching the power supply state to the film heating unit 60 of the shrink packaging unit 160 in an arbitrary client-specific setting. The preheating start condition and the heating start condition of the client-specific setting in FIG. 4 will be described in association with each other.

When the preheating of the binding material heating unit 54 is not started in any of the plurality of binding units 154 positioned upstream of the shrink packaging unit 160 (step S31), the control unit 180 switches the film heating unit 60 to an OFF state (step S32). When the preheating of the binding material heating unit 54 is started in any of the plurality of binding units 154 (step S31), the control unit 180 switches the film heating unit 60 to a preheating state (step S33). Subsequently, when the heating of the binding material heating unit 54 is started in any of the plurality of binding units 154 (step S34), the control unit 180 switches the film heating unit 60 to a heating state (step S35). Then, when the wound paper money bundle is fed to the shrink packaging unit 160 and the shrink packaging is completed (step S36), the power supply state of the film heating unit 60 becomes OFF (step S37) and the process returns to step S31 to repeat the subsequent processes.

In a case where the film heating unit 60 has only two stages, i.e., the OFF state and the heating state, steps S31 and S33 described above are omitted.

According to the present embodiment, since the banding material heating unit 52 of the banding unit 152 does not always maintain the thermal bonding temperature but supplies the power only when the thermal bonding is needed, it is possible to suppress power consumption. In addition, since the binding material heating unit 54 of the binding unit 154 does not always maintain the thermal bonding temperature but supplies the power only when the thermal bonding is needed, it is possible to suppress power consumption. Furthermore, since the film heating unit 60 of the shrink packaging unit 160 also does not always maintain the shrink packaging temperature but supplies the power only when the shrink packaging is needed, it is possible to suppress power consumption.

Thus, since the power supply state to each unit of the banding/binding module 150 and the shrink packaging unit 160 is improved, the energy saving of the paper money processing apparatus is realized.

The paper money processing described above with reference to FIGS. 6, 7, and 8 is performed in such a manner that the CPU, that is, the control unit 180 having a processor, controls each unit (100, 110, 120, 130, 140, 151, 152, 153, 154, 160, 170, etc.) based on the information stored in the client-specific setting storing unit 80 according to a program.

The accumulating unit 151, the banding unit 152, the bunch accumulating unit 153, and the binding unit 154 are not limited to two lanes with respect to each denomination. For example, one accumulating unit 151 and one banding unit 152 may be provided in the apparatus with respect to one denomination. In this case, when 100 sheets of paper moneys are accumulated in the first accumulating unit 151, the 100 sheets of the paper moneys are separated by a separator. After that, the paper moneys conveyed to the accumulating unit 151 are accumulated on the separator. When the paper moneys of the accumulating unit 151 are ejected, the paper moneys on the separator may be transferred to the accumulating unit 151.

In addition, in the present embodiment, the shrink packaging unit 160 is illustrated, but it may be omitted when the shrink packaging is not needed.

In addition, the bunch accumulating unit 153 and the binding unit 154 may be provided on the common conveyance path R and may be omitted if necessary.

Although, in the above embodiment, the client of the paper money to be processed is stored in the client-specific setting storing unit 80, any modification is permitted so long as storing information about a distribution of the number of sheets with respect to each denomination. For example, a case where the number of sheets of 10,000-yen bills is large is set as A pattern, a standard case is set as B pattern, and a case where the number of 1,000-yen bills is large is set as C pattern. The table of FIG. 4 may be replaced with these patterns from A to C and one of the stored patterns may be selected during processing.

As such, by associating the information about the number of sheets with respect to each client or each denomination, with the number of accumulated sheets to which the heating is to be started, it is possible to reduce the power consumption of the lane and it is possible to provide the paper money processing apparatus realizing the energy saving.

### Another Embodiment

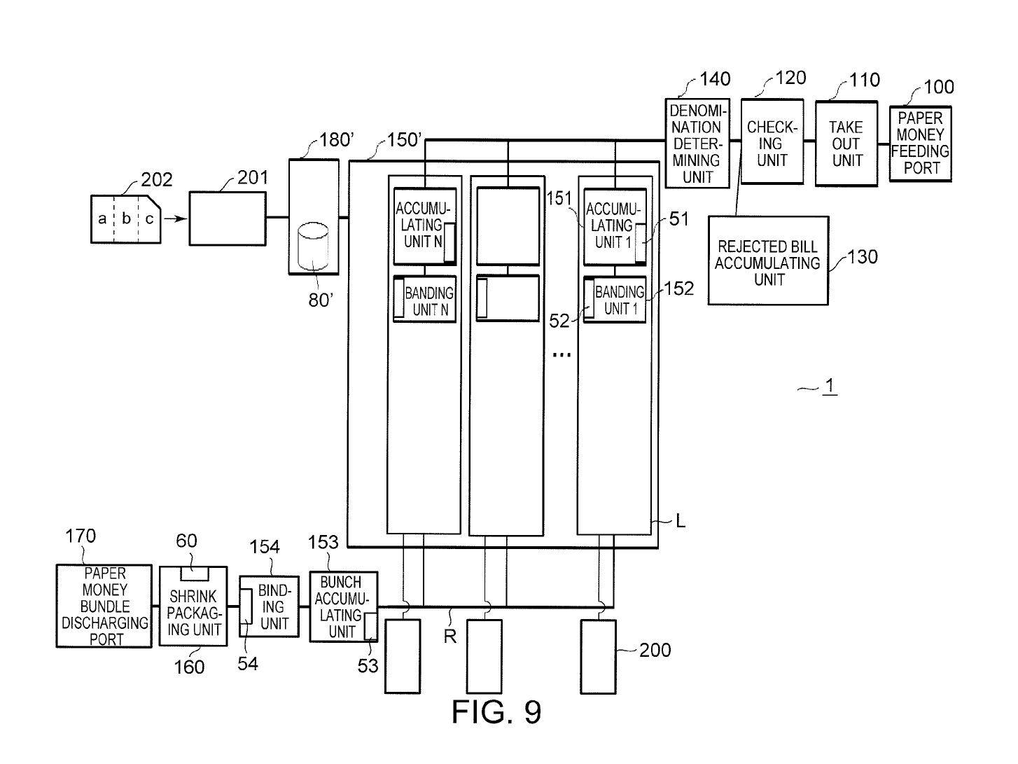

FIG. 9 is a configuration diagram of a paper money processing apparatus according to another embodiment. The same parts as those of FIG. 1 are denoted with the same reference numerals, and detailed descriptions thereof will be omitted.

In the embodiment of FIG. 9, each lane L includes a driving unit 200 (driver). Each driving unit 200 includes a driving circuit that drives an accumulating unit 151 and a banding unit 152. In addition, each driving unit 200 may include a power supply, or power may be supplied from one power supply to each driving unit 200. Since each lane L has the driving unit 200, each lane L can be independently operated.

For example, it is possible to operate an arbitrary lane L and pause the other lanes. In addition, it is possible to increase a paper money accumulating speed of an arbitrary lane L and slow down a paper money accumulating speed of the other lanes. In order to change the paper money accumulating speed, the rotating speed of the impeller is changed in a case where the accumulating unit 151 is configured by the rotating impeller.

The paper money processing apparatus of FIG. 9 includes an input unit 201. The input unit 201 is a terminal input device. For example, the input unit 201 is an optical reader. The input unit 201 may be an electric or magnetic card reader or a keyboard. Batch information 202 to be processed by the paper money processing apparatus is input to the input unit 201. Then, the input batch information 202 is stored in a storing unit 80′ (memory).

The control unit 180′ (controller) includes, for example, a CPU, a memory, a peripheral circuit, and the like. The storing unit 80′ includes, for example, rewritable ROM or RAM.

The batch information 202 is information about the denomination of the paper money to be processed and includes information a, b, c, . . . such as the number of sheets of paper moneys or the order of the paper money processing. For example, ‘a’ may be the number of sheets of 1,000-yen bills, ‘b’ may be the number of sheets of 5,000-yen bills, and ‘c’ may be the number of sheets of 10,000-yen bills. For example, in a case where the batch information 202 includes the information a to c about these denominations and information d about the order of flowing paper moneys, a time zone when the 1,000-yen bills flows out selectively drives a lane L1 that processes the 1,000-yen bills, a time zone when the 5,000-yen bills flows out selectively drives a lane L2 that processes the 5,000-yen bills, and a time zone when the 10,000-yen bills flows out selectively drives a lane L3 that processes the 1,000-yen bills. At that time, the power supply to unselected lanes are paused. For example, when the lane L1 is driven, the lanes other than the lane L1 are paused. In addition, when the lane L2 is driven, the lanes other than the lane L2 are paused. Then, when the lane L3 is driven, the lanes other than the lane L3 are paused. Therefore, only the lane L that is processing the paper moneys is driven, and the power supply to the other lanes is paused. Then, when reaching a predetermined number of sheets of paper moneys, for example, 100 sheets of paper moneys, the paper moneys are banded by the banding unit 152.

The batch information 202 may include only the information a to c about the number of sheets of each denomination. In a case where the information a to c about the number of sheets of each denomination, that is, the number of sheets of the 1,000-yen bills, the number of sheets of the 5,000-yen bills, and the number of sheets of the 10,000-yen bills, are input as the batch information 202, if the number of sheets is a>b>c, it is possible to process the paper moneys such that the accumulating speed of the accumulating unit 151 of the lane L1 of the 1,000-yen bills are fastest and the accumulating speed of the accumulating unit 151 of the lane L3 of the 10,000-yen bills are slowest.

The control of the accumulating speed of the accumulating unit 151 of the lane can be variously applied. For example, in a case where the batch information 202 includes the information a to c about the denomination and the information d about the order of the flowing paper moneys and a>b>c is satisfied (a is the number of sheets of the 1,000-yen bills, b is the number of sheets of the 5,000-yen bills, and c is the number of sheets of the 10,000-yen bills), the time zone when the 1,000-yen bills having a large processing amount flow out can increase the accumulating speed of the accumulating unit of the lane L1 that processes the 1,000-yen bills. In addition, in this case, the time zone when the 10,000-yen bills having a small processing amount flow out can slow down the accumulating speed of the accumulating unit of the lane L3 that processes the 10,000-yen bills.

As described above, in a case where only the lane L that processes the paper moneys is selectively driven, or in a case where the accumulating speed of each lane is individually controlled, it is possible to stop the power supply to the banding unit 152 of the lane in which the accumulating or banding is not performed.

That is, in a case where only the lane L that processes the paper moneys is selectively driven and the other lanes are paused, the power is supplied to only the accumulating unit 151 (and the banding unit 152) of the lane L that processes the paper moneys, and the power supply to the heater of the banding unit 152 of the lane (the heater of the banding material heating unit 52) that does not perform the accumulating or the banding can be stopped or can be reduced to a preheating level. In addition, in a case where the accumulating speed of the accumulating unit 151 of each lane is individually controlled, the power supply to the heater of the banding unit 152 of the lane that does not perform the accumulating or the banding can be stopped or can be reduced to a preheating level.

That is, the individual driving of the accumulating unit 151 and the individual control of the heater may be performed solely or may be performed in combination. In addition, the individual control of the accumulating speed of the accumulating unit 151 and the individual control of the heater may be performed solely or may be performed in combination. Then, when the banding is completed, the power supply to the heater is stopped again or returns to the preheating level.

The above-described paper money processing is performed in such a manner that the CPU, that is, the control unit 180′ having a processor, controls each unit (100, 110, 120, 130, 140, 151, 152, 153, 154, 160, 170, 200, 201, etc.) based on the information stored in the storing unit 80′ according to a program.

That is, the individual driving of the lane L as described above (the driving/stopping, the control of the accumulating speed, and the control of the banding unit) can be performed such a manner that the control unit 180′ individually controls each driving circuit 200 included in each lane L, based on the batch information 202 incorporated from the input unit 201 to the storing unit 80′, and individually controls the accumulating unit 151 and the banding unit 152 included in each lane L accordingly.

The individual driving of the accumulating unit 151 and the individual control of the heater may be performed solely or may be performed in combination. If necessary, the paper moneys having different denominations can be accumulated in each lane at the same speed, and the power supply to the heater of only the banding unit in the lane that is not used in the banding can be stopped or can be reduced to a preheating level. At that time, in a case where the batch processing amount (a+b+c) to be processed is large, it is also possible to increase the accumulating speed of each accumulating unit 151 of the respective lanes L1 to L3.

Besides, the selective driving of the lane L and the control of the accumulating speed may be performed in combination.

In FIG. 9, the bunch accumulating unit 153 and the binding unit 154 are provided on the common conveyance path R. Therefore, in the embodiment of FIG. 9, a banding module 150′ is configured by the plurality of lanes L each including the accumulating unit 151 and the banding unit 152. In the embodiment of FIG. 9, the banding unit 152 is provided in each lane L, but the banding unit 152 common to each lane L may be provided between the lane and the common conveyance path R, if desired.

According to the embodiment of FIG. 9, since each lane L is individually driven by the driving circuit 200, it is possible to significantly reduce the energy consumption of the paper money processing apparatus.

In addition, the paper money processing apparatuses of FIGS. 1 and 9 are configured such that each lane is individually controlled. Therefore, each lane has a normal active mode and an energy saving mode, and it is possible to process the paper moneys with low power consumption.

In the embodiments of FIGS. 1 and 9, yen is used as the paper money, but it is possible to apply to other paper money, such as dollar or euro. Besides, as to the material of the paper money, paper, cloth, polymer or the like may be used.

### REFERENCE SIGNS LIST

1 paper money processing apparatus
L lane (processing unit)
110 take out unit
150, 150′ banding/binding module, banding module
151 accumulating unit (first accumulating unit)
152 banding unit
153 bunch accumulating unit (second accumulating unit)
154 binding unit
51 sheet counting unit (first counter)
52 banding material heating unit
53 bunch counting unit (second counter)
54 binding material heating unit
160 shrink packaging unit
film heating unit
180, 180′ control unit (controller)
80, 80′ client-specific setting storing unit, storing unit (memory)
200 driving unit (driver)

While certain embodiments have been described, these embodiments have been presented by way of example only, and are not intended to limit the scope of the inventions. Indeed, the novel embodiments described herein may be embodied in a variety of other forms; furthermore, various omissions substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A money processing apparatus comprising:
a take out unit that takes out sheet-like moneys one by one;
a denomination determining unit that determines denominations of the sheet-like moneys taken out by the take out unit; and
a plurality of processing units that discriminates the sheet-like moneys determined by the denomination determining unit and accumulates the sheet-like moneys according to the denomination,
wherein power supply to the plurality of processing units having different denominations is individually controlled.

2. The money processing apparatus according to claim 1,
wherein each of the plurality of processing units comprises an accumulating unit, and
wherein the money processing apparatus comprises:
a counter that counts the number of sheets of sheet-like moneys accumulated in each accumulating unit;
a plurality of banding units that, when the number of sheets of the accumulated sheet-like moneys, which is counted by the counter, becomes a predetermined number of sheets, ejects the predetermined number of the sheet-like moneys, winds a thermal-bonding band, performs a thermal bonding by using a banding material heating unit;
a memory that stores information about a distribution of the number of sheets with respect to a client or a denomination of sheet-like moneys to be processed, an accumulating unit to accumulate sheet-like moneys by a denomination, and the number of accumulated sheets to which heating is to be started when the banding material heating unit is heated, in association with each other; and
a controller that performs heating to a thermally bondable temperature by starting to supply power to a banding material heating unit of a corresponding banding unit when the number of sheets of the accumulated sheet-like moneys, which is counted by the counter, reaches the number of the accumulated sheets to which the heating is to be started, which is stored in the memory, and stops the supply of the power to the banding material heating unit when the thermal bonding is completed.

3. The money processing apparatus according to claim 2,
wherein the memory further stores the number of accumulated sheets to which preheating is to be started, when the banding material heating unit starts to be preheated, and
wherein the controller further starts supply of preheating power to a banding material heating unit of a corresponding banding unit when the number of sheets of the accumulated sheet-like moneys, which is counted by the counter, reaches the number of accumulated sheets to which the preheating is to be started.

4. The money processing apparatus according to claim 2,
wherein the counter is a first counter,
wherein the money processing apparatus further comprises:
a plurality of second accumulating units that accumulates sheet-like money bunches banded by the banding unit with respect to each denomination;
a second counter that counts the number of sheet-like money bunches accumulated in each of the second accumulating units; and
a plurality of binding units that, when the number of the accumulated sheet-like money bunches, which is counted by the each second counter, becomes a predetermined number of accumulated sheet-like money bunches, ejects the predetermined number of the sheet-like money bunches, winds a thermal-bonding band, performs a thermal bonding by using a binding material heating unit, and
wherein when the binding material heating unit starts to be heated to a thermally bondable temperature, the storing unit further stores the number of accumulated bunches to which heating is to be started and the number of accumulated sheets in association with each other, and
wherein when the number of the sheet-like money bunches, which is counted by the each second counter, and the number of the accumulated sheet-like moneys, which is counted by the first counter, reach the number of the accumulated bunches to which the heating is to be started and the number of the accumulated sheets, which are stored in the storing unit, the control unit further starts supply of power to a binding material heating unit of a corresponding binding unit and heats the binding material heating unit to a thermally bondable temperature, and when the thermal bonding is completed, the control unit stops the supply of the power to the binding material heating unit.

5. The money processing apparatus according to claim 4,
wherein the memory further stores the number of accumulated bunches and the number of the accumulated sheets to which preheating is to be started, when a heating unit of the binding unit starts to be preheated, and
wherein when the number of the sheet-like money bunches and the number of the accumulated sheet-like moneys, which are counted by the second counter and the first counter, reach the number of the accumulated bunches and the number of the accumulated sheets to which the preheating is to be started, which are stored in the memory, the controller further starts supply of preheating power to a binding material heating unit of a corresponding binding unit.

6. The money processing apparatus according to claim 4, further comprising a shrink packaging unit that packages a sheet-like money bundle bound by the binding unit by covering the sheet-like money bundle with a heat-shrinkable film and heat-shrinking the heat-shrinkable film by using a film heating unit,
wherein the memory further stores a predetermined heating start condition when the film heating unit of the shrink packaging unit starts to be heated to a heat-shrinkable temperature, and
wherein when the heating start condition is satisfied, the controller further starts supply of power to the film heating unit of the shrink packaging unit and heats to the heat-shrinkable temperature, and when the packaging is completed, the control unit stops the supply of the power to the film heating unit.

7. The money processing apparatus according to claim 6,
wherein the memory further stores a predetermined preheating start condition when the film heating unit starts to be preheated, and
wherein when the preheating start condition is satisfied, the controller further starts supply of preheating power to the film heating unit of the shrink packaging unit.

8. The money processing apparatus according to claim 1,
wherein each of the plurality of processing units includes an accumulating unit and a banding unit, and each accumulating unit and each banding unit are individually controlled.

9. The money processing apparatus according to claim 1,
wherein each of the plurality of processing units includes an accumulating unit, and supply of power to accumulating units of different processing units is individually controlled.

10. The money processing apparatus according to claim 1,
wherein each of the plurality of processing units includes an accumulating unit, and accumulating speeds of accumulating units of different processing units are individually controlled.

11. The money processing apparatus according to claim 1,
wherein each of the plurality of processing units includes a banding unit, and supply of power to banding units of different processing units is individually controlled.

12. The money processing apparatus according to claim 9,
wherein each of the plurality of processing units includes a banding unit, and supply of power to banding units of different processing units is individually controlled.

13. The money processing apparatus according to claim 10,
wherein each of the plurality of processing units includes a banding unit, and supply of power to banding units of different processing units is individually controlled.

14. The money processing apparatus according to claim 1,
wherein each of the plurality of processing units includes a driver.

15. The money processing apparatus according to claim 1, further comprising a memory that stores batch information.

16. A money processing method comprising:
taking out sheet-like moneys one by one from a take out unit;
determining denomination of the sheet-like money taken out by the take out unit;
discriminating the sheet-like moneys determined by the denomination determining unit and accumulating the sheet-like moneys in a plurality of processing unit according to the denomination; and
individually controlling the plurality of processing units having different denominations.

17. The money processing method according to claim 16, further comprising banding the sheet-like moneys according to the number of accumulated sheets to which heating is to be started with respect to the sheet-like moneys to be processed.

18. The money processing method according to claim 16, further comprising individually controlling the accumulating and banding of the plurality of processing units with respect to each processing unit.
